(19) United States
(12) Patent Application Publication
(10) Pub. No.: US 2022/0400026 A1
(43) Pub. Date: Dec. 15, 2022

(54) RETROSPECTION ASSISTANT FOR VIRTUAL MEETINGS

(71) Applicant: Microsoft Technology Licensing, LLC, Redmond, WA (US)

(72) Inventors: Seema GUGGARI, Santa Clara, CA (US); Lincoln L. LIU, Chino Hills, CA (US); Brian D. REMICK, Morgan Hill, CA (US)

(73) Assignee: Microsoft Technology Licensing, LLC, Redmond, WA (US)

(21) Appl. No.: 17/348,501

(22) Filed: Jun. 15, 2021

(51) Int. Cl. H04L 12/18; G06F 40/20; G06N 20/00

(52) U.S. Cl. CPC H04L 12/1831; G06F 40/20; G06N 20/00

(57) ABSTRACT

A meeting record of a meeting attended by a user via a meeting application is received. Sentiment analysis the meeting record is performed to identify one or more key events in the meeting, and retrospective feedback for the one or more key events identified in the meeting is determined. The retrospective feedback identifies respective actions or non-actions by the user in connection with respective key events among the one or more key events, and includes respective feedback on the respective actions or non-actions to recommend modified behavior of the user in subsequent meetings. The retrospective feedback is provided for display to the user.

### BACKGROUND

Virtual meeting applications are often used by individuals, organizations, etc., for conducting meetings, delivering presentations, providing services, etc. For example, a virtual meeting application may be used to conduct a virtual job interview meeting, to conduct a virtual sales pitch meeting, to virtually interact with coworkers or friends, etc. Such virtual interactions, however, are often not as effective as face-to-face interactions. In some cases, for example, a meeting participant may be less aware of the effects of reactions or behaviors on one or more other participants in a virtual meeting as compared to awareness that the meeting participant may have in a face-to-face meeting. The ineffectiveness of virtual interactions may be costly to individuals and organizations. For example, if an interviewer in a virtual interview meeting interacts sub-optimally, the company could lose a potentially good candidate, and it may also be harmful to the company's reputation. As another example, if a sales representative of an organization inadvertently miscommunicates during a virtual sales pitch meeting, the organization may lose a potentially important deal, which may result in significant monetary and strategic losses to the organization.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, retrospective feedback may be generated by a virtual interactions retrospection assistant based on a recording of a virtual meeting, such as a video and/or audio recording of the virtual meeting, a transcription of the virtual meeting, etc. The retrospective feedback may be generated for one or more key events, such as negative sentiment events and/or positive sentiment events, that may be identified in the meeting. The retrospective feedback may include suggested responses or behaviors that could have been employed by the user during the meeting, such as words, phrases, sentences, etc., that could have been used by the user; facial expression or gestures that could have been employed by the user; words, phrases, expressions, etc., that could have been avoided by the user, etc. Such retrospective feedback may be displayed to the user, for example, at appropriate times during the meeting and/or at a time after the completion of the meeting. The user may view the retrospective feedback, and may learn, from the retrospective feedback, responses and behaviors that may, for example, improve user's interactions in subsequent meetings.

In aspects, a system is provided. The system includes at least one processor and at least one memory storing computer-executable instructions that, when executed by the at least one processor, cause the at least one processor to perform operations. The operations include receiving a meeting record of a meeting attended by a user via a meeting application, and performing sentiment analysis of the meeting record to identify one or more key events in the meeting. The one or more key events include at least one key event that is associated with a negative sentiment. The operations further include determining retrospective feedback for the one or more key events. The retrospective feedback identifies at least one action or non-action by the user determined to have caused the negative sentiment and includes at least one respective suggestion for an alternative action or non-action determined to avoid the negative sentiment. The operations additionally include causing the retrospective feedback to be displayed to the user.

In further aspects, a method for generating retrospection is provided. The method includes receiving a meeting record of a meeting attended by a user via a meeting application, and performing sentiment analysis of the meeting record to identify one or more key events in the meeting. The method also includes determining retrospective feedback for the one or more key events identified in the meeting. The retrospective feedback identifies respective actions or non-actions by the user in connection with respective key events among the one or more key events, and includes respective feedback on the respective actions or non-actions to recommend modified behavior of the user in subsequent meetings. The method additionally includes providing the retrospective feedback for display to the user.

In still further aspects, a computer storage medium is provided. The computer storage medium stores computer-executable instructions that when executed by at least one processor cause a computer system to perform operations. The operations include receiving a meeting record of a meeting attended by a user via a meeting application, and performing sentiment analysis of the meeting record to identify one or more key events in the meeting. The one or more key events include at least one key event that is associated with a positive sentiment. The operations also include determining retrospective feedback for the one or more key events. The retrospective feedback includes feedback that reinforces at least one action or non-action by the user determined to have caused the positive sentiment. The operations additionally include causing the retrospective feedback to be displayed to the user.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 is a block diagram of a system in which retrospective feedback may be generated by a virtual interactions retrospection assistant for a meeting participant, in accordance with an aspects of the present disclosure.

FIG. 2 depicts a block diagram of an example key event identification system that may be utilized for training the virtual interactions retrospection assistant of FIG. 1, in accordance with aspects of the present disclosure.

FIG. 3 a block diagram of an example training dataset generator that may be utilized for training the virtual interactions retrospection assistant of FIG. 1, in accordance with aspects of the present disclosure.

FIG. 4 depicts a block diagram of an example retrospective feedback generation system that may be utilized with the virtual interactions retrospection assistant of FIG. 1, in accordance with aspects of the present disclosure.

FIG. 5 depicts details of a method for generating retrospective feedback, in accordance with aspects of the present disclosure.

FIG. 6 is a block diagram illustrating physical components (e.g., hardware) of a computing device with which aspects of the disclosure may be practiced.

FIGS. 7A-7B illustrate a mobile computing device with which aspects of the disclosure may be practiced.

FIG. 8 illustrates an example architecture of a system in which aspects of the disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In virtual interaction applications, such as virtual meeting applications, participants are often unware of harmful effects that participants' reactions and behaviors have on other participants in the virtual meetings. Because participants in virtual meeting applications may be unaware of harmful effects of the participants' reactions or behaviors during virtual meetings, the participants may be likely to repeat such reactions or behaviors in subsequent meetings. In accordance with examples of the present disclosure, retrospective feedback may be generated and provided to one or more participants in a virtual meeting to suggest or recommend behaviors that may improve participants' interactions in subsequent meetings.

In aspects, retrospective feedback may be generated by a virtual interactions retrospection assistant (“VIRA”) system based on a meeting record of a meeting, such as a video and/or audio recording of the meeting, a transcription of the meeting etc. The retrospective feedback may be generated for one or more events that may be associated with particular sentiments, such as negative sentiments and/or positive sentiments, that may be detected in the meeting. The one or more events may include, for example, situations in which uncomfortable or inappropriate facial expressions (e.g., smile, frown, etc.) or sounds may be detected, uncomfortable or inappropriate comments may be made, and the like. The retrospective feedback may identify the one or more events detected in the meeting and include suggested responses that could have been employed by the user during the meeting and/or avoided by the user during the meeting, such as words, phrases, sentences, etc., that could have been used or avoided by the user, facial expression or gestures that could have been employed or avoided by the user, etc., for example to avoid negative sentiments in the meeting and/or to reinforce positive sentiments in the meeting. The retrospective feedback may be provided to one or more users participating in the meeting, for example in real-time during the meeting or after completion of (e.g., immediately following) the meeting. The one or more users may view the retrospective feedback, and may learn, from the retrospective feedback, responses and behaviors that may, for example, improve users' interactions in subsequent meetings.

In aspects, the VIRA system may perform sentiment analysis of a meeting record of a meeting to identify one or more key events in the meeting, such as negative sentiment events and/or positive sentiment events that may be detected in the meeting. The VIRA system may, for example, process video and/or audio components of the meeting record to detect one or more of: facial expressions, posture, voice tone, vocal intensity, speech content (e.g., words, phrases, sentences, etc.), etc., of one or more users participating in the meeting, that may indicate particular sentiments, such as negative and/or positive sentiments, in the meeting. The VIRA system may then generate retrospective feedback for only the one or more key events identified in the meeting rather than, for example, generating retrospective feedback for the entirety of the meeting. In at least some aspects, performing sentiment analysis of the meeting record to identify one or more key events in the meeting, and generating retrospective feedback for the one or more key events identified in the meeting, enables the VIRA system to efficiently generate retrospective feedback, for example by processing only a subset of segments or frames of a recording of the meeting corresponding to the key events identified in the meeting. For example, in aspects, because only a subset of segments or frames of a recording of a meeting corresponding to key events needs to be processed to generate retrospective feedback for the meeting, the VIRA system may be implemented with lower computational complexity and/or reduced computational resources, such as processing power, memory, etc., as compared to implementations in which greater number of segments or frames (e.g., corresponding to a recording of the entirety of the meeting) are processed. Moreover, in at least some aspects, generating retrospective feedback for only one or more key events identified in a meeting ensures that targeted and useful retrospective feedback is provided to the participants in the meeting.

In aspects, the VIRA system may generate retrospective feedback using one or more retrospective feedback generator models (e.g., machine learning models, neural networks, etc.) that may be trained or otherwise configured to generate suggested responses for key events that may be identified in meetings. In an aspect, the one or more retrospective feedback generator models may be trained using one or more training datasets that include key events identified in meeting records obtained from previous meetings and annotated, e.g., by human coaching experts, with suggested ideal responses for the key events identified in the previous meetings. In at least some aspects, because the VIRA system generates retrospective feedback using one or more retrospective feedback generator models that are trained based on datasets annotated by human coaching experts, expert feedback may be automatically generated and provided to users without any further input from expert coaches.

In some aspects, the VIRA system may generate retrospective feedback for a user participating in a meeting based in part on a type of the meeting (e.g., based on whether the meeting is a virtual interview meeting or a virtual sales pitch meeting) and/or a role of the user in the meeting (e.g., based on whether the user is an interviewer or an interviewee in a virtual interview meeting). For example, the VIRA system may employ a plurality of retrospective feedback generator models that may be trained to generate retrospective feedback for different types of meetings. In aspects, in response to receiving a request to generate retrospective feedback for a meeting, the VIRA system may determine a type of the meeting, for example based on information that may be associated with the meeting (e.g., meeting title, meeting participants, etc.), and may select an appropriate feedback generator model for generating retrospective feedback for the meeting based on the determined type of the meeting. As another example, the VIRA system may determine a role of a user in a meeting, for example by analyzing user information associated with the user (e.g., user's title, user's employment status, etc.) and/or meeting information associated with the meeting (e.g., a list of participants in the meeting, an originator of the meeting, etc.) and/or by analyzing interactions between participants in the meeting record of the meeting. The VIRA system may then generate retrospective feedback for the user participating in the meeting based on the determined role of the user in the meeting. For example, the VIRA system may provide the determined role of the user as an input to a retrospective feedback generator model used for generating retrospective feedback for the user. Thus, in aspects, retrospective feedback for one or more key events identified for a particular user participating in a first meeting, such as a virtual interview meeting, may be different from retrospective feedback generated for same or similar key events that may be identified for the particular user in a second meeting, such as a virtual sales pitch meeting. As another example, retrospective feedback generated for a first user participating in a particular meeting, such as an interviewer in a particular virtual interview meeting, may be different from retrospective feedback that may be generated for a second user participating in the particular meeting, such as an interviewee in the particular virtual interview meeting. In these ways, the VIRA system may generate targeted and useful retrospective feedback for various participants in various meetings.

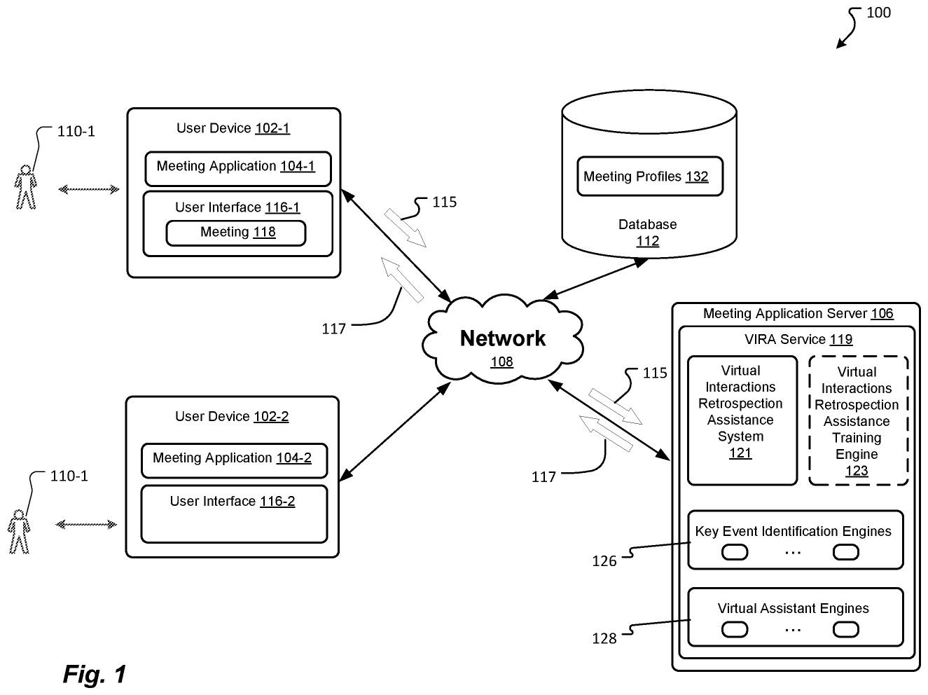

FIG. 1 is a block diagram of a system 100 in which retrospective feedback may be generated by a virtual interactions retrospection assistant for a meeting participant, in accordance with an aspects of the present disclosure. The system 100 may include a plurality of user devices 102 that may be configured to run or otherwise execute client applications 104. The user devices 102 may include, but are not limited to, laptops, tablets, smartphones, and the like. The applications 104 may include applications having meeting features (“meeting applications”), such as video conferencing applications, video chat applications, collaboration applications, and the like. Non-limiting examples of applications 104 include Microsoft™ Teams™, Microsoft™ Skype™ Zoom™, Google™ Hangouts™, Google™ Classroom™, and Cisco™ WebEX™. In some examples, the applications 104 may include web applications, where such applications 104 may run or otherwise execute instructions within web browsers. In some examples, the applications 104 may additionally or alternatively include native client applications residing on the user devices 102.

The user devices 102 may be communicatively coupled to a meeting application server 106 via a network 108. The network 108 may be a wide area network (WAN) such as the Internet, a local area network (LAN), or any other suit able type of network. The network 108 may be single network or may be made up of multiple different networks, in some examples. The system 100 may also include a profiles database 112. The profiles database 112 may be communicatively coupled to the meeting application server 106 and/or to the one or more user devices 102 via the network 108, as illustrated in FIG. 1, or may be coupled to the meeting application server 106 and/or to the one or more user devices 102 in other suitable manners. For example, the profiles database 112 may be directly connected to the meeting application server 106, or may be included as part of the meeting application server 106, in some examples. The profiles database 112 may be a single database or may include multiple different databases.

Users 110 may conduct various virtual meetings, such as virtual interviews, virtual sales pitches, virtual performance reviews, corporate meetings, personal meetings, etc., via the meeting applications 104. In aspects, the meeting applications 104 may obtain retrospective feedback for users 110, and may display the retrospective feedback to the users 110. The retrospective feedback may indicate, to the users 110, suggested ideal responses in one or more situations that may be identified as key events in the meeting, such as one or more negative sentiment events, positive sentiment events, etc., that may have occurred in the meeting. As an example, an interviewer in a virtual interview meeting may be provided with retrospective feedback that identifies a situation in which the interviewer made a comment, a gesture, or a facial expression that may not have been appropriate in a virtual interview setting and may have negatively affected the interviewee, for example. As another example, a sales representative in a virtual sales pitch meeting may have made a comment or sound, or may have used an expression, that was perceived to be aggressive by other participants in the sales pitch meeting. The retrospective feedback may additionally indicate a suggested response or behavior by the interviewer that would have been better received in the identified situation during the interview meeting. For example, the retrospective feedback may suggest a better comment, describe a better facial expression, indicate a better gesture, etc., that could have been employed by the user 110 during the meeting. The users 110 may view the retrospective feedback, and may learn, from the retrospective feedback, responses and behaviors that may, for example, improve interactions of users 110 in subsequent meetings.

In an aspect, a meeting application 104 (e.g., the meeting application 104-1), running a meeting 118 in a user interface 116, may generate a meeting record 115, and may transmit the meeting record 115 to the meeting application server 106. The meeting record 115 may comprise one or more of a video recording of the meeting 118, an audio recording of the meeting 118, a transcript of the meeting 118, etc. The meeting record 115 may be received by a VIRA service 119 that may be running or otherwise executing on the meeting application server 106. The VIRA service 119 may include a VIRA system 121. In some aspects, the VIRA service 119 may also include a VIRA training engine 123. While the VIRA system 121 and the VIRA training engine 123 are illustrated as being executed by the meeting application server 106, the VIRA system 121 and/or VIRA training engine 123 may be at least partially executed at a meeting client application 104 of a client device 102 and/or at least partially executed at a device separate from the meeting application server 106 and the client device 102.

The VIRA system 121 may analyze the meeting record 115 to identify one or more key events in the meeting record 115. For example, the VIRA system 121 may perform sentiment analysis of the meeting record 115 to identify events that may have negative and/or positive sentiment content. In an aspect, the VIRA system 121 may employ one or more key event identification engines 126 to identify the one or more key events in the meeting record 115. The one or more key event identification engines 126 may be included with the VIRA service 119, as illustrated in FIG. 1, and/or may be accessible by the VIRA service 119, e.g., via the network 108.

In aspects, the one or more key event identification engines 126 may comprise one or more machine learning models (e.g., machine learning models, neural networks, etc.) that may be trained or otherwise configured to identify various types of events, such as negative and/or positive sentiment events. In an aspect, the key event identification engines 126 may comprise respective models trained to identify key events in various types of meetings, such as interview meetings, sales pitch meetings, corporate meetings, personal meetings, and the like. In an aspect, the VIRA system 121 may determine the type of the meeting 118, for example, by accessing an identifier of the meeting 118, and/or a meeting profile 132 that may be stored in the profiles database 112 in association with the identifier of the meeting 118. The VIRA system 121 may then select a particular key event identification engine 126 to be used for identifying key events in the meeting record 115 based on the determined type of the meeting 118. In other aspects, the VIRA system 121 may utilize a single key event identification engine 126 that may be trained or otherwise configured to identify key events in meeting records for meetings of multiple or all types of meetings that may be conducted via the meeting applications 104.

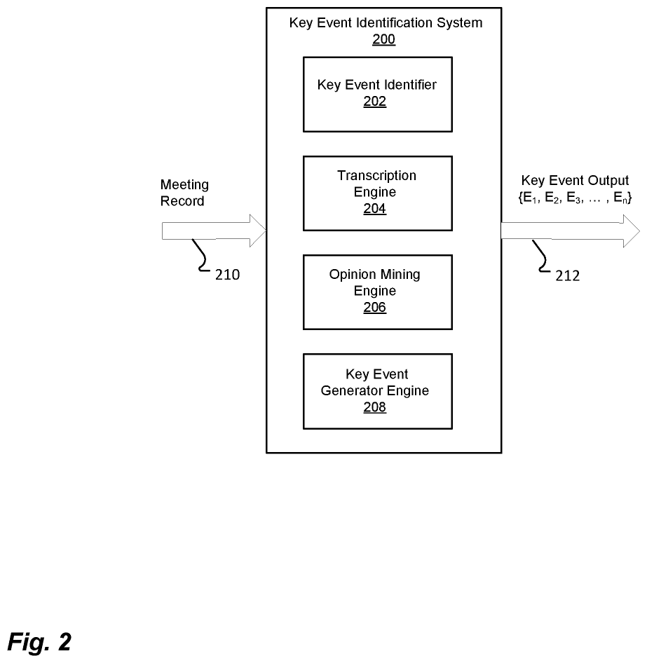

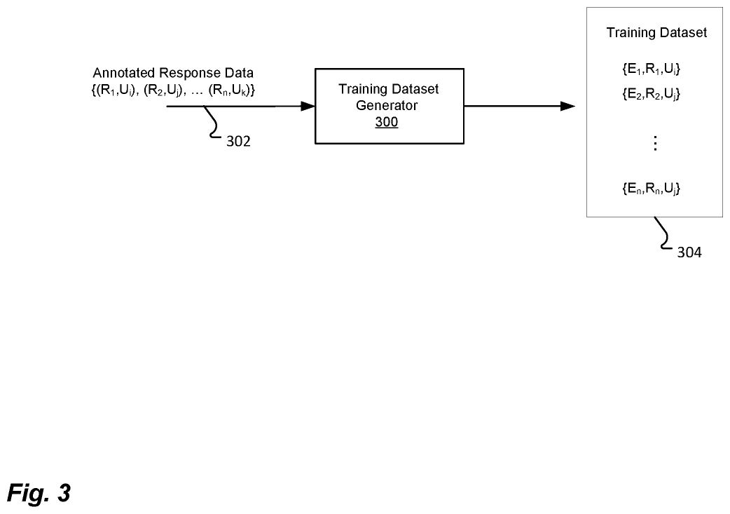

In aspects, the VIRA system 121 may generate retrospective feedback 117, and may cause the retrospective feedback 117 to be provided to the user device 102-1 for display to the user 110-1. In aspects, the retrospective feedback 117 may be displayed to the user 110-1 in the user interface 116-1 of the meeting application 104-1 or may be displayed to the user 110-1 in another suitable user interface, such as a user interface of another suitable application that may be running or otherwise executing on the user device 102-1. In aspects, the retrospective feedback 117 may be displayed to the user 110-1 in real time during the meeting 118 and/or after completion of the meeting 118. The retrospective feedback 117 may include the one or more key events identified in the meeting record 115 and one or more suggested responses that could have been employed by the user 110-1, for example to avoid or lessen negative sentiments and/or to reinforce positive sentiments when same or similar key events occur in future virtual meetings. The VIRA system 121 may generate retrospective feedback using one or more virtual assistant engines 128, for example. The one or more virtual assistant engines 128 may comprise one or more models (e.g., machine learning models, neural networks, etc.) that may be trained or otherwise configured to generate suggested responses for key events that may be identified in meetings. In aspects, the one or more virtual assistant engines 128 may include respective virtual assistant engines 128 trained or otherwise configured to generate suggested responses for key events for respective types of meetings and/or for respective roles of users in the meetings. In an aspect, the one or more virtual assistant engines 128 may be trained using one or more training datasets that include key events identified in meeting records obtained from previous meetings and annotated, e.g., by one or more human coaching experts, with suggested ideal responses for the key events identified in the one or more previous meetings. Such one or more training datasets may be generated by a VIRA training engine 123 that may be included with the VIRA service 119, as illustrated in FIG. 1, or may be provided separately from the VIRA service 119. Generation of datasets that may be used for training of the one or more virtual assistant engines 128, according to some aspects, are described in more detail below with reference to FIGS. 2-3.

In an aspect, the retrospective feedback 117 may be transmitted to the user device 102-1 via the network 108. The meeting application 104-1 may receive the retrospective feedback 117 and may display the retrospective feedback 117 to the user 110-1 (e.g., in the user interface 116-1 of the meeting application 104-1 or in another suitable user interface that may be provided on the user device 102-1). The user 110-1 may thus view the retrospective feedback 117, and may learn, from the retrospective feedback 117, responses and behaviors that may, for example, improve the user's interactions in subsequent meetings. In some aspects, the meeting application 104-1 may prompt the user 110-1 to provide opinions regarding usefulness of suggested responses provided in the retrospective feedback 117. For example, the meeting application 104-1 may prompt the user 110-1 to rate usefulness of suggested responses provided in the retrospective feedback 117. Such opinion (e.g., rating) information may be provided, for example, to the VIRA training engine 123 and may be used in subsequent training or tuning of the virtual assistant agents 128, for example.

FIG. 2 depicts a block diagram of an example key event identification system 200, in accordance with aspects of the present disclosure. In an example, the example key event identification system 200 may be utilized with the VIRA system 121 and/or the VIRA training engine 123 of FIG. 1. For ease of explanation, the key event identification system 200 is described with reference to FIG. 1. In another example, the key event identification system 200 may be utilized in a system different from the system 100 of FIG. 1.

The key event identification system 200 includes a key event identifier 202, a transcription engine 204, an opinion mining engine 206 and a key event generator engine 208. A meeting record 210 of a meeting may be provided to the key event identifier 202. The meeting record 210 may include a video and/or audio recording of the meeting, for example. The key event identifier 202 may perform sentiment analysis of the meeting record 210 to identify one or more key events in the meeting. The key event identifier 202 may, for example, processes video and/or audio components of the meeting record 210 to identify the one or more key events by detecting one or more of facial expressions, posture, voice tone, vocal intensity, speech content (e.g., words, phrases, sentences, etc.), etc., of one or more users participating in the meeting, that may indicate particular sentiments, such as negative and/or positive sentiments, in the meeting. In an aspect, the key event identifier 202 may employ one or more machine learning models, such as one or more neural networks, that may be trained to identify key events, such as negative sentiment events and/or positive sentiment events in recordings of meetings. In an aspect, the key event identifier 202 may employ a particular machine learning model that may be trained for identifying key events in meetings of a particular meeting type (e.g., an interview, a sales pitch, a corporate meeting, a personal meeting, etc.). In an aspect, the type of the meeting may be determined by the key event identification system 200 based on meeting information (e.g., a meeting profile) that may be accessible by the key event identification system 200. In another aspect, the key event identification system 200 may determine the type of the meeting based on an indication that may be included in the meeting record 210. In other aspects, the type of the meeting may be determined by the key event identification system 200 in other suitable manners.

In some aspects, the transcription engine 204 may generate a transcription of the meeting record 210 for further analysis by the key event identification system 200. The transcription of the meeting record 210 may be analyzed by the opinion mining engine 206, for example. The opinion mining engine 206 may utilize suitable analysis techniques, such as natural language processing techniques, to identify key events based on textual representation of the meeting. Output of the opinion mining engine 206 may comprise indications of when the one or more identified key events occurred during the meeting. For example, a key event may be identified in the output of the opinion mining engine 206 by a time stamp that may indicate a start time and an end time of the key event relative to a beginning of the meeting and/or duration time of the key event in the meeting.

The key events identified by the key event identifier 202 and/or the opinion mining engine 206 may be provided to the key event generator engine 208. The key event generator engine 208 may generate a combined key event output 212. For example, the key event generator engine 208 may identify video and/or audio clips or segments corresponding to the key events based on the time stamps provided by the key event identifier 202 and/or the opinion mining engine 206, and parse the identified video and/or audio clips or segments from the meeting record 115. The key event generator engine 208 may splice the parsed video and/or audio clips or segments from the meeting record 115 to generate the combined key event output 212. In aspects, the combined key event output 212 may be utilized for generating training data for training the one or more virtual assistant engines 128. For example, the combined key event output 212 may be transmitted to a user device, such as a user device 102, of an expert coach who may then annotate the key events in the key event output 212 with suggested ideal user responses in connection with the key events identified in the meeting. The key events annotated by the expert coach may be used to generate a training dataset that may be utilized to train the one or more virtual assistant engines 128.

FIG. 3 a block diagram of an example training dataset generator 300, in accordance with aspects of the present disclosure. In an example, the training dataset generator 300 may be utilized with the VIRA training engine 123 of FIG. 1. For ease of explanation, the training dataset generator 300 is described with reference to FIG. 1. In another example, the training dataset generator 300 may be utilized in a system different from the system 100 of FIG. 1.

The training dataset generator 300 may receive annotation input corresponding to key events identified by the key event identification system 200, and may generate a dataset 304 for training one or more VIRA models. In an aspect, the dataset 304 may comprise a plurality of entries 306, each entry 306 comprising a key event E, a suggested ideal response R, and a user role U. In an aspect, the suggested ideal responses R may correspond to responses provided by, or generated based on input from, one or more expert coaches analyzing the corresponding events E. In an aspect, a suggested ideal response R may be in the form of text (e.g., word, phrase, sentence, etc.) that may have been employed by the user in connection with the corresponding key event E. In an aspect, the suggested ideal response R may additionally or alternatively include a textual explanation of a suggested expression (e.g., facial expression), a gesture, etc., that may have been employed by the user in the corresponding key event E. The user role U may identify the role of the user that may have employed the suggested ideal response R in the meeting. As an example, the role U of a user may be indicated as an interviewer, an interviewee, a sales representative, an employer, etc. In this case, suggestions may be different based on the role U of the user. In other aspects, the dataset 304 may comprise key event training data in other suitable formats.

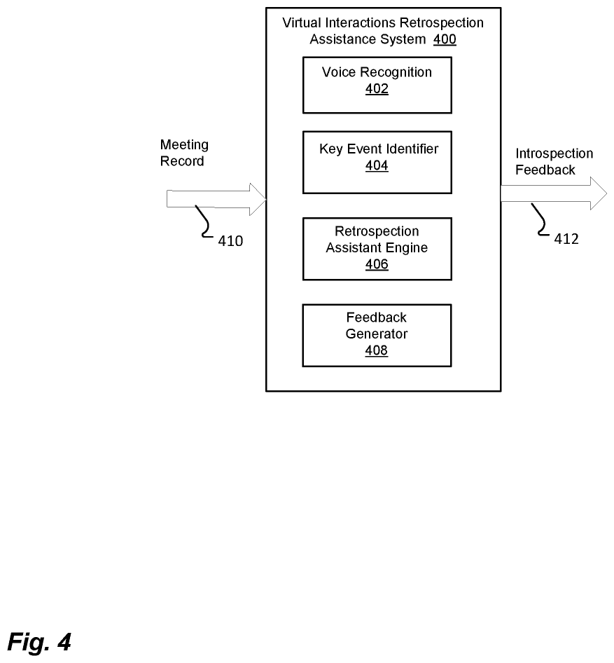

FIG. 4 depicts a block diagram of an example VIRA system 400, in accordance with aspects of the present disclosure. In an example, the VIRA system 400 corresponds to the VIRA system 121 of FIG. 1. For ease of explanation, the VIRA system 400 is described with reference to FIG. 1. In another example, the VIRA system 400 may be utilized in a system different from the system 100 of FIG. 1.

The VIRA system 400 may be configured to generate one or more respective retrospective feedbacks 412 for one or more users 110 attending a meeting via respective meeting applications 104 by the users 110. The VIRA system 400 may include a voice recognition engine 402, a key event identifier 404, a retrospection assistance engine 406 and a feedback generator 408. The VIRA system 400 may generally be configured to generate one or more retrospective feedbacks 412 based on a meeting record 410 that may include, for example, a video and/or audio recording of the meeting.

The voice recognition engine 402 may be configured identify a user 110 based on a voice signal that may be received from the user 110. In an aspect, the voice signal received from the user 110 may capture a response provided by the user 110 to a prompt or a question presented by the meeting application 104 to the user 110. The prompt or the question may request a confirmation that the user 110 wishes to receive retrospective feedback on the meeting. In an aspect, the identification of the user 110 may be utilized by the VIRA system 400 to determine a role of the user 110 in the meeting. As an example, in an aspect in which the meeting is a virtual interview meeting, the VIRA system 400 may determine whether the user 110 is the interviewer or the interviewee in the meeting. The VIRA system 400 may determine the role of the user 110 in the meeting based on user information (e.g., user's title, user's employment status, user settings in the meeting application, user calendar, user emails, etc.) associated with the user 110 and/or meeting information (e.g., meeting profile) associated with the meeting. In an aspect, the user information and/or the meeting information may be stored, for example, in the database 112 may be accessed by the VIRA system 400, for example via the network 108. In an example, the VIRA system 400 may analyze information associated with the meeting, such as a list of invitees to the meeting, to determine the role of the user 110 in the meeting. For example, the VIRA system 400 may determine that the user 100 is the interviewer in the virtual interview meeting if the user 110 is the organizer of the meeting. In some aspects, the VIRA system 400 may additionally or alternatively analyze interactions between users in the meeting record 410 of the meeting, and may determine a role of the user based on the analysis of interactions between the users in the meeting. For example, the VIRA system 400 may determine that a user is an interviewer in a virtual interview meeting based on determining that the user asks a relatively larger number of questions in the meeting as compared to another user who may be an interviewee in the virtual interview meeting. In other aspects, the VIRA system 400 may additionally or alternatively employ other suitable techniques to determine a role of a user in the meeting.

The key event identifier 404 may identify one or more key events in the meeting record 410. The key event identifier 404 may be the same as or similar to the key event identifier 202 and/or the key opinion mining engine 206 of FIG. 2. In some aspects, the key event identifier 404 may employ one or more models, such as machine learning models, neural networks etc., trained to identify negative and/or positive sentiment events, for example. In an aspect, the key event identifier 404 may employ one of a plurality of available models trained for specific types of meetings. Thus, for example, the key event identifier 404 may select a particular model to be used for identifying key events in the meeting based on an indicator of a type of the meeting. In other aspects, the key event identifier 404 additionally or alternatively utilizes other suitable key event identification techniques to identify the one or more key events in the meeting record 410.

In an aspect, the key event identifier 404 may identify one or more key events for a user 110 by analyzing facial expressions, posture, voice tone, vocal intensity, speech content (e.g., words, phrases, sentences, etc.), etc., to identify actions or non-actions of the user 110 that may have caused particular sentiments, such as negative and/or positive sentiments, in the meeting. In an aspect, the key event identifier 404 may identify the one or more key events for the user 110 by analyzing facial expressions, posture, voice tone, vocal intensity, speech content (e.g., words, phrases, sentences, etc.), etc., of the user 110 and one or more other users 110 participating in the meeting. In this way, the key event identifier 404 may identify key events that may be relevant to a particular user 110 based on actions or non-actions of the particular user 110 as well as based on effects that the actions or non-actions of the particular user 110 may have had on one or more other participants in the meeting. In some aspects, the key event identifier 404 may identify different sets of key events for different users 110 participating in the meeting. For example, the key event identifier may identify a first set of key events for a first user 110 participating in a meeting by identifying actions or non-actions of the first user 110 that may have caused negative or positive sentiments in the meeting, and may identify a second set of key events for a second user 110. The retrospection assistant engine 406 may analyze the one or more key events identified by the key event identifier 404, and may generate the retrospective feedback 412 to be provided to a user 110. In an aspect, the retrospective feedback 412 may include feedback that may allow the user 110 to recommend modified behavior in subsequent meetings that may be attended by the user 110, for example to make the user 110 more effective in interacting with other users in the subsequent meetings that may be attended by the user 110. In an aspect, the retrospective feedback 412 may identify respective actions or non-actions by the user 110 in connection with key events identified by the key event identifier 404, and may include feedback on the respective actions or non-actions to recommend modified behavior of the user in subsequent meetings. For example, the retrospective feedback 412 may identify at least one action or non-action by the user determined to have caused a negative sentiment, and may include at least one suggestion for an alternative action or non-action determined to avoid the negative sentiment. As another example, the retrospective feedback 412 may identify at least one action or non-action by the user determined to have caused a positive sentiment, and may include feedback reinforcing the one or more actions of non-actions that have caused the positive sentiment.

In an aspect, the retrospection assistant engine 406 may generate retrospective feedback 412 for a user 110 based on the role of the user 110 in the meeting, to provide specific feedback that may be more relevant to the role of the user 110 in the meeting. For example, ideal actions or non-actions for an interviewer in a virtual interview meeting may be different from ideal actions or non-actions for an interviewee in the virtual interview meeting. As another example, ideal actions or non-actions for a sales representative in a virtual sales pitch meeting may be different from ideal actions or non-actions for a technical manager who may also be attending the virtual sales pitch meeting. Accordingly, in an aspect, the retrospective feedback 412 generated by the retrospection assistant engine 406 for a first user 110 attending the meeting (e.g., an interviewer in a virtual interview meeting, a sales representative in a virtual sales pitch meeting, etc.) may provide different suggested actions or non-actions from actions or non-actions suggested by the retrospective feedback 412 generated by the retrospection assistant engine 406 for a second user 110 attending the meeting (e.g., an interviewee in the virtual interview meeting, a technical manager in a virtual sales pitch meeting, etc.). As a more specific example, a suggestion for a representative in a sales pitch meeting may be to use lower and more even vocal intensity to avoid perception of being overly aggressive, whereas a suggestion for a technical manager in the virtual sales pitch meeting may be to speak more loudly to project more confidence and expertise, for example. In these ways, the retrospection assistant engine 406 may generate more targeted retrospective feedback for different users that may be more useful in subsequent meetings that may be attended by the particular users.

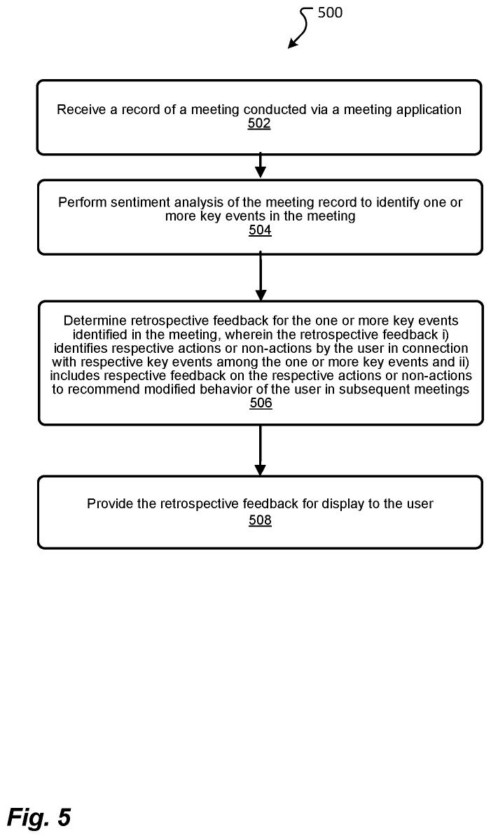

FIG. 5 depicts details of a method 500 for generating retrospective feedback, in accordance with aspects of the present disclosure. A general order for the steps of the method 500 is shown in FIG. 5. The method 500 can be executed as a set of computer-executable instructions executed by a computer system and encoded or stored on a computer readable medium. Further, the method 500 can be performed by gates or circuits associated with a processor, Application Specific Integrated Circuit (ASIC), a field programmable gate array (FPGA), a system on chip (SOC), or other hardware device. Hereinafter, the method 500 shall be explained with reference to the systems, components, modules, software, data structures, user interfaces, etc. described in conjunction with FIGS. 1-4.

At block 502, a meeting record of a meeting conducted via a meeting application may be received. For example, one of the meeting record 115 of FIG. 1, the meeting record 210 of FIG. 2 and the meeting record 410 of FIG. 4 is received. In other aspects, a suitable meeting record different from the meeting record 115 of FIG. 1, the meeting record 210 of FIG. 2 and the meeting record 410 of FIG. 4 is received. The meeting record may include a video and/or audio recording of at least a portion of the meeting. In some aspects, the meeting record may additionally include other information about the meeting, such as an indicator of a type of the meeting, roles of participants in the meeting, etc.

At block 504, one or more key events in the meeting are identified based on the meeting record received at block 502. For example, sentiment analysis of the meeting record received at block 502 is performed to identify the one or more key events in the meeting. The one or more key events may include events associated with detected actions of non-actions by one or users participating in the meeting. In aspects, the one or more key events may be identified by detecting one or more of facial expressions, posture, voice tone, vocal intensity, speech content (e.g., words, phrases, sentences, etc.), etc., of one or more users participating in the meeting, that may indicate a particular sentiment, such as a negative or a positive sentiment, in the meeting. For example, the one or more key events may include a user looking in a certain direction, such as up and to the left, which may indicate that the user may be lying, or may be perceived to be lying. As another example, an increase in volume or intensity of voice of a user may be detected, which may indicate that the user is, or may be perceived, to be overly aggressive, agitated or angry. As yet another example, raised eyebrows of a user may be detected, which may indicate that the user is surprised by a statement or behavior of another user in the meeting. As another example, a comment made by a user may be identified as causing negative or positive sentiment of one or more other users in the meeting. In other aspects, other facial expressions (e.g., smile frown, eye gaze or movement, etc.), voice intensity, textual content, etc. may be identified as key events associated with particular sentiments, such as negative and/or positive sentiments.

In an aspect, the one or more events are identified at block 504 as described above in connection with one or more of the VIRA system 121 of FIG. 1, the key event identifier 202 of FIG. 2 and the key event identifier 404 of FIG. 4. In aspects, the key events are identified using one or more models (e.g., machine learning models, neural networks, etc.) that are trained or otherwise configured to identify events having negative sentiment and/or positive sentiment content. In other aspects, the one or more key events are identified in other suitable manners.

At block 506, retrospective feedback to be provided to a user associated with the meeting is determined. In an aspect, the retrospective feedback 117 of FIG. 1 or the retrospective feedback 412 of FIG. 4 is determined. In other aspects, suitable retrospective feedback different from the retrospective feedback 117 of FIG. 1 or the retrospective feedback 412 of FIG. 4 is determined. In aspects, the retrospective feedback is generated using one or more models (e.g., machine learning models, neural networks, etc.) that are trained or otherwise configured to provide suggested responses in connection with key events that may be identified in records of meetings conducted between users. In aspects, the retrospective feedback is generated using one or more models trained based on one or more previous meetings annotated with appropriate responses by a human expert coach, for example. In an aspect, the retrospective feedback includes respective suggested responses that could have been employed by the user in connection with the one or more key events identified in the meeting. For example, the respective feedback may include words, phrases, sentences, etc., that could have been said by the user, facial expressions and/or gestures that could have been employed by the user, etc. In an aspect, the retrospective feedback may identify respective actions or non-actions by the user in connection with respective key events among the one or more key events, and may include respective feedback on the respective actions or non-actions to recommend modified behavior of the user in subsequent meetings. For example, the retrospective feedback may identify at least one action or non-action by the user determined to have caused a negative sentiment an identified key event that is associated with the negative sentiment, and include at least one suggestion for an alternative action or non-action determined to avoid the negative sentiment. As a more specific example, in an aspect in which a detected action by the user is looking in a particular direction, such as up and to the left, the suggested alternative action may be to avoid looking in the particular direction to remove potential perception that the user may be lying. As another example, in an aspect in which a detected action by the user is an increase of voice volume or intensity, the suggested alternative action may be use more even vocal volume or intensity to avoid perception that the user may be overly aggressive, agitated or angry. In some aspects, the retrospective feedback may additionally or alternatively identify at least one action or non-action by the user determined to have caused a positive sentiment to reinforce the at least one action of non-action that have caused the positive sentiment.

At block 508, provide the retrospective feedback for display to the user. In an aspect, the retrospective feedback is displayed to the user in a user interface of the meeting application. In other aspects, the retrospective feedback is displayed to the user in other suitable manners. The retrospective feedback may be displayed to the user during the meeting or at a time after completion of the meeting, such as immediately after the meeting. The user may view the retrospective feedback, and may learn, from the retrospective feedback, responses and behaviors that may, for example, improve user's interactions in subsequent meetings.

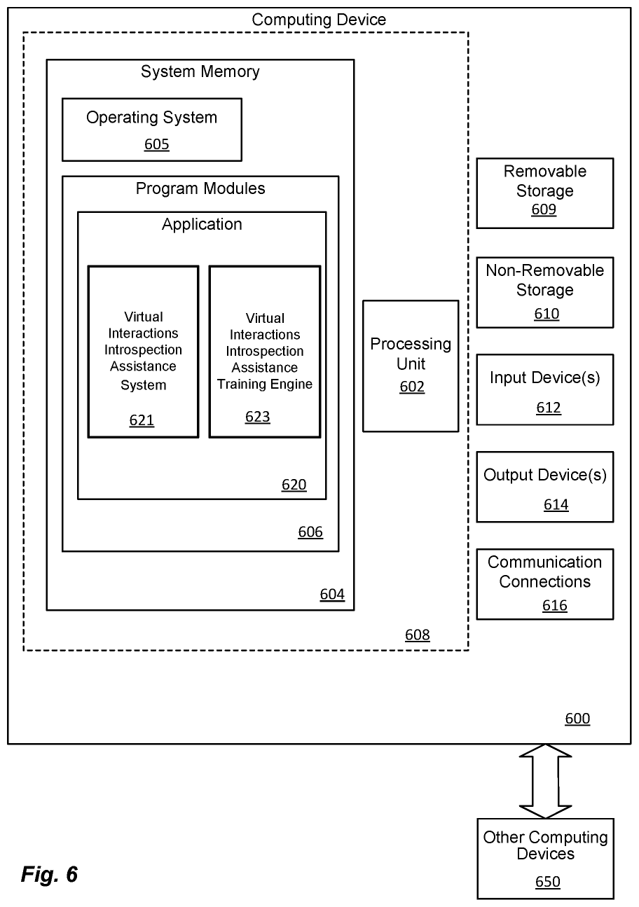

FIGS. 6-8 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store a virtual interactions retrospection assistance engine 621 (e.g., corresponding to the VIRA system 121 of FIG. 1) and/or a VIRA training engine 623 (e.g., corresponding to the VIRA training engine 123 of FIG. 1). The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the at least one processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

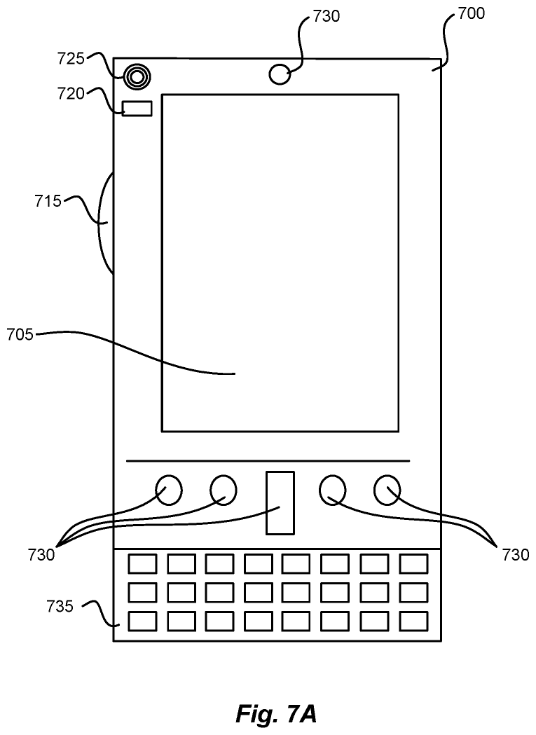

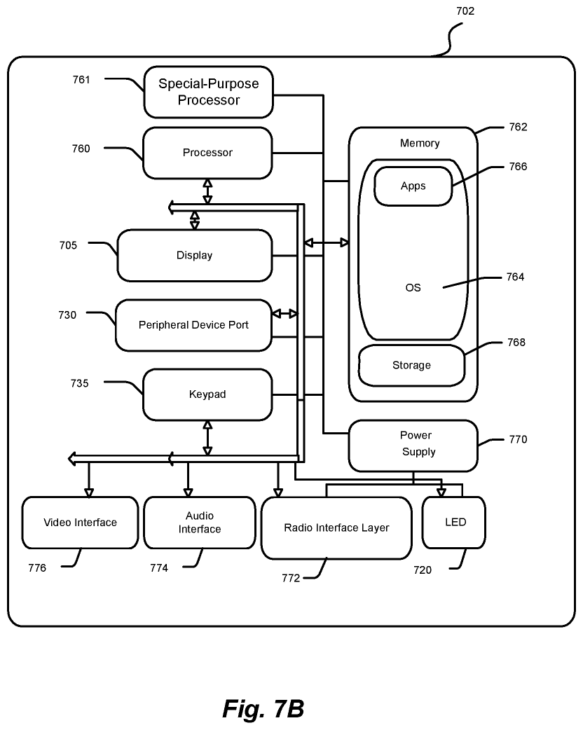

FIGS. 7A-7B illustrate a mobile computing device 700, for example, a mobile telephone, a smart phone, wearable computer (such as a smart watch), a tablet computer, a laptop computer, and the like, with which aspects of the disclosure may be practiced. In some aspects, the client (e.g., computing system 104A-E) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external source.

FIG. 7B is a block diagram illustrating the architecture of one aspect of computing device, a server, or a mobile computing device. That is, the computing device 700 can incorporate a system (e.g., an architecture) 702 to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., search engine, extractor module, relevancy ranking module, answer scoring module, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

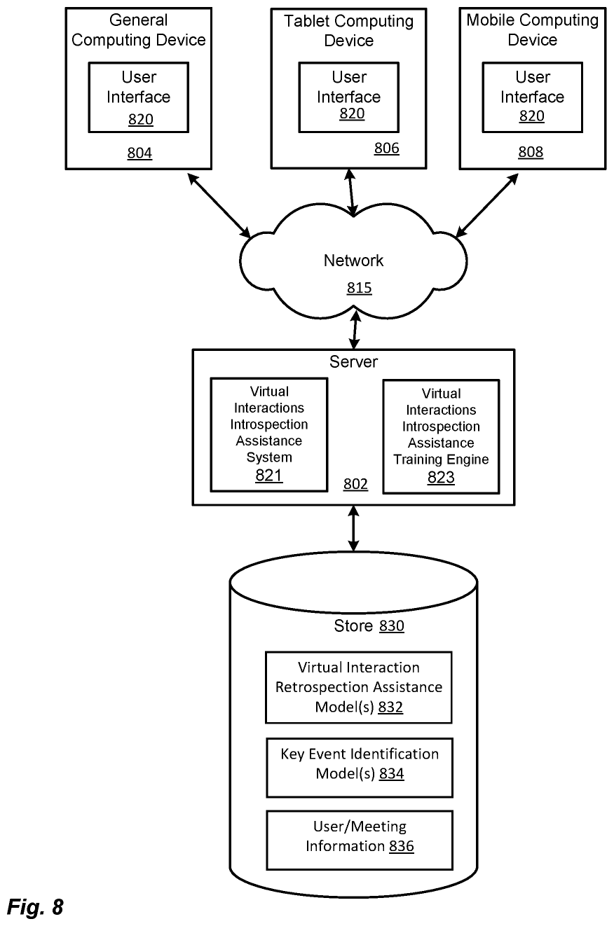

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types.

A virtual interactions retrospection assistance engine 821 (e.g., corresponding to the VIRA system 121 of FIG. 1) and/or a VIRA training engine 823 (e.g., corresponding to the VIRA training engine 123 of FIG. 1) may be employed by a client that communicates with server device 802, and/or the virtual interactions retrospection assistance engine 821 and/or the VIRA training engine 823 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from a store 830, in addition to receiving graphical data useable to be either pre-processed at a graphic-originating system, or post-processed at a receiving computing system. The store 830 may include for example, key event identification model(s) store 832 that may store parameters of one or more key event identification models (e.g., that may be utilized by the one or more key event identification engines 126), virtual interaction retrospection model(s) store 734 that may store parameters of one or more virtual interaction retrospection models (e.g., that may be utilized by the one or more virtual assistant engines 128), and/or user/meeting information store 734 that may store information about meetings and/or users participating in the meetings.

FIG. 8 illustrates an exemplary mobile computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the present disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
at least one memory storing computer-executable instructions that, when executed by the at least one processor, cause the at least one processor to:
receive a meeting record of a meeting attended by a user via a meeting application;
perform sentiment analysis of the meeting record to identify one or more key events in the meeting, the one or more key events including at least one key event that is associated with a negative sentiment;
determine retrospective feedback for the one or more key events, wherein the retrospective feedback identifies at least one action or non-action by the user determined to have caused the negative sentiment and includes at least one respective suggestion for an alternative action or non-action determined to avoid the negative sentiment; and
cause the retrospective feedback to be displayed to the user.

2. The system of claim 1, wherein the computer-executable instructions, when executed by the at least one processor, cause the at least one processor to determine, based on one or both of i) user information associated with the user and ii) meeting information associated with the meeting, a role of the user in the meeting, wherein the retrospective feedback is generated based at least in part on the role of the user in the meeting.

3. The system of claim 1, wherein the retrospective feedback includes textual information indicating one or more of i) suggested words for use in connection with the at least one key event, ii) suggested facial expressions for use in connection with the at least one key event or iii) suggested gestures for use in connection with the at least one key event.

4. The system of claim 1, wherein
the one or more key events further include at least one key event associated with a positive sentiment, and
the retrospective feedback further includes feedback that reinforces at least one action or non-action by the user determined to have caused the positive sentiment.

5. The system of claim 1, wherein the retrospective feedback is generated using one or more machine learning models trained to provide suggested responses to key events identified in meetings.

6. The system of claim 5, wherein the machine learning model is trained based on a dataset that comprises a plurality of annotated key events identified in previously recorded meetings.

7. The system of claim 5, wherein the computer-executable instructions, when executed by the at least one processor, cause the at least one processor to display the retrospective feedback to the user one or both of i) in real time during the meeting and ii) after completion of the meeting.

8. A method for generating retrospection, the method comprising:
receiving a meeting record of a meeting attended by a user via a meeting application;
performing sentiment analysis of the meeting record to identify one or more key events in the meeting;
determining retrospective feedback for the one or more key events identified in the meeting, wherein the retrospective feedback identifies respective actions or non-actions by the user in connection with respective key events among the one or more key events, and includes respective feedback on the respective actions or non-actions to recommend modified behavior of the user in subsequent meetings; and
providing the retrospective feedback for display to the user.

9. The method of claim 8, wherein identifying the one or more key events in the meeting includes identifying the one or more key events using a machine learning model trained to identify one or both of i) negative sentiment events and ii) positive sentiment events.

10. The method of claim 8, wherein
the record of the meeting includes a recording of the meeting; and
performing sentiment analysis of the meeting record to identify one or more key events in the meeting includes
generating a transcription of the recording of the meeting, and
performing opinion mining based on the transcription of the recording of the meeting to identify one or both of i) negative sentiment events or ii) positive sentiment events in the transcription of the recording of the meeting.

11. The method of claim 8, wherein determining retrospective feedback to be provided to the user comprises determining the retrospective feedback using a machine learning model trained based on a training dataset that comprises a plurality of key events identified in one or more previous meetings, the plurality of key events annotated with suggested ideal responses by participants in the previous meetings.

12. The method of claim 8, further comprising:
receiving one or more recordings of one or more previous meetings,
identifying one or more key events in the one or more recordings of the one or more previous meetings, and
causing the one or more key events to be displayed for annotation to one or more expert coaches.

13. The method of claim 12, further comprising
receiving the one or more key events annotated by the one or more expert coaches, and
generating a training dataset to include the one or more key events annotated by the one or more expert coaches.

14. The method of claim 13, further comprising training, using the training dataset, a machine learning model to generate feedback for key events identified in recordings of future meetings.

15. A computer storage medium storing computer-executable instructions that when executed by at least one processor cause a computer system to:
receive a meeting record of a meeting attended by a user via a meeting application;
perform sentiment analysis of the meeting record to identify one or more key events in the meeting, the one or more key events including at least one key event that is associated with a positive sentiment;
determine retrospective feedback for the one or more key events, wherein the retrospective feedback includes feedback that reinforces at least one action or non-action by the user determined to have caused the positive sentiment; and
cause the retrospective feedback to be displayed to the user.

16. The computer storage medium of claim 15, wherein the computer-executable instructions, when executed by the at least one processor, further cause the computer system to determine, based on one or both of i) user information associated with the user and ii) meeting information associated with the meeting, a role of the user in the meeting, wherein the retrospective feedback is generated based at least in part on the role of the user in the meeting.

17. The computer storage medium of claim 14, wherein the retrospective feedback includes textual information indicating one or more of i) suggested words for use in connection with the one or more key events, ii) suggested facial expressions for use in connection with the one or more key events or iii) suggested gestures for use in connection with the one or more key events.

18. The computer storage medium of claim 17, wherein the one or more key events include at least one negative sentiment event.

19. The computer storage medium of claim 15, wherein the retrospective feedback is generated using one or more machine learning models trained to provide suggested responses to key events identified in meetings.

20. The computer storage medium of claim 19, wherein the machine learning model is trained based on a dataset that comprises a plurality of annotated key events identified in previously recorded meetings.
